(19) United States
(12) Patent Application Publication
(10) Pub. No.: US 2009/0115698 A1
(43) Pub. Date: May 7, 2009

(54) Plasma display device and driving method thereof

(76) Inventors: Sang-Hoon Yim, Suwon-si (KR); Hak-Cheol Yang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,635

(22) Filed: Oct. 31, 2008

(30) Foreign Application Priority Data
Nov. 2, 2007 (KR) 10-2007-0111555

(51) Int. Cl. G09G 3/28

(52) U.S. Cl. 345/60

(57) ABSTRACT

In a plasma display device, a single frame is divided into a plurality of subfields each having a luminance weight value, and a plurality of video signals, each corresponding to the plurality of discharge cells, are converted into a plurality of subfield data indicating whether or not light emission is performed in each of the plurality of subfields. The converted subfield data is changed based on relative light emission rates of the discharge cells so that light emission of the discharge cells is in correspondence.

### BACKGROUND OF THE INVENTION

1. Field of the Invention

Embodiments relate to a plasma display device and its driving method.

2. Description of the Related Art

The plasma display device is a display device using a plasma display panel that displays characters or images by using plasma generated by a gas discharge. The plasma display panel includes a plurality of cells arranged in a matrix form thereon.

The plasma display device is driven (operated) by dividing a frame into a plurality of sub-frames each having a luminance weight value. Light-emitting cells and non-light-emitting cells are selected during an address period of each subfield, and a sustain discharge occurs by the number corresponding to the weight value of the corresponding subfields in the light-emitting cells during a sustain period of each subfield.

In the plasma display device, a gray scale of a discharge cell is determined by the sum of the weight values of subfields during which the discharge cell emits light. However, each phosphor of the cell has a different light emission rate. These different light emission rates result in blurring an image. Thus, image blurs are generated in video, particularly with a large amount of motion, resulting in images that are not precisely displayed.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a plasma display device and a driving method, which substantially overcome one or more of the problems and disadvantages of the related art.

It is a feature of an embodiment to provide a plasma display device and a driving method in which image blur is reduced or eliminated.

It is another feature of an embodiment to provide a plasma display device and a driving method which compensate for different phosphor emission rates.

At least one of the above and other features and advantages may be realized by providing a method for driving a plasma display device having a plurality of discharge cells, the method including dividing a single frame into a plurality of subfield data each having a luminance weight value, converting a plurality of video signals, each corresponding to the plurality of discharge cells, into a plurality of subfield data indicating whether or not light emission is performed in the plurality of subfields, changing the converted subfield data based on an light emission rate of the plurality of discharge cells, and discharging the plurality of discharge cells with the changed subfield data.

The plurality of discharge cells may include a plurality of first discharge cells that emit light of a first color at a first light emission rate and a plurality of second discharge cells that emit light of a second color at a second light emission rate. Changing the converted subfield data may include changing the converted subfield data for first discharge cells when the first light emission rate is slower than the second light emission rate and changing the converted subfield data for second discharge cells when the second light emission rate is slower than the first light emission rate.

When the second light emission rate is slower than the first light emission rate, changing may include changing at least one bit of subfield data of the second discharge cells in an Nth frame to at least one bit of subfield data of the second discharge cells in a (N+1)th frame (where N is a positive integer).

The method may further include determining a number of bits to be changed based on a difference between the first and second light emission rates.

Subfield data of the first discharge cells may not be changed.

When the second light emission rate is slower than the first light emission rate by one frame or more, changing may include changing all bits of subfield data of the second discharge cells in the Nth frame to all bits of subfield data of the second discharge cells in the (N+1)th frame.

When the second light emission rate is slower than the first light emission rate by j sub-fields, changing may include changing j-bits of subfield data of the second discharge cells in the Nth frame to corresponding j-bits of subfield data of the second discharge cells in the (N+1)th frame.

The at least one bit of changed subfield data may be a higher order bit.

The method may include calculating a screen load ratio from the plurality of video signals, determining a total number of sustain pulses during the frame according to the screen load ratio, and determining the number of sustain pulses allocated to each of the plurality of subfields based on the total number of sustain pulses.

At least one of the above and other features and advantages may be realized by providing a plasma display device, including a first discharge cell configured to emit light of a first color at a first light emission rate, a second discharge cell configured to emit light of a second color at a second light emission rate, a controller configured to divide a single frame into a plurality of subfields each having a weight value, convert video signals of the first and second discharge cells into first and second subfield data indicating whether or not light emission is performed in the plurality of subfields, and change one of the converted first and second subfield data based on a difference between first and second light emission rates, and a driver configured to selectively make the first and second discharge cells emit light or not emit light according to the first and second subfield data.

The controller may include a subfield data generator configured to convert the video signals of the first and second discharge cells into the first and second subfield data, respectively, and a subfield data changing unit configured to change subfield data of discharge cells among the first and second discharge cells having a lower light emission rate.

When second light emission rate is slower than the first light emission rate, the subfield data changing unit may be configured to change at least one bit of subfield data of the second discharge cells in an Nth frame to at least one bit of subfield data of the second discharge cells in a (N+1)th frame (where N is a positive integer).

The subfield data changing unit may be configured to determine a number of bits to be changed based on a difference between the first and second light emission rates.

The subfield data changing unit may be configured to maintain subfield data of the first discharge cells.

When second light emission rate is slower than the first light emission rate by one frame or more, the subfield data changing unit may be configured to change all bits of subfield data of the second discharge cells in the Nth frame to all bits of subfield data of the second discharge cells in the (N+1)th frame.

When second light emission rate is slower than the first light emission rate by j sub-fields, the subfield data changing unit may be configured to change j-bits of subfield data of the second discharge cells in the Nth frame to corresponding j-bits of subfield data of the second discharge cells in the (N+1)th frame.

The at least one bit of changed subfield data may be a higher order bit.

At least one of the above and other features and advantages may be realized by providing a method for driving a plasma display device including a plurality of discharge cells, the method including dividing a single frame into a plurality of subfield data, converting video signals of first and second discharge cells input during a Nth frame into first and second subfield data (where N is a positive integer), converting video signals of the first and second discharge cells input during a (N+1)th frame into third and fourth subfield data, respectively, changing at least one bit of the second subfield data in the Nth frame into at least one bit of the fourth subfield data of the (N+1)th frame, when a second light emission rate of the second discharge cell is slower than a first light emission rate of the first discharge cell, and selectively making the first and second discharge cells emit light or not emit light based on the first subfield data and the changed second subfield data in the N frame.

The method may include determining a number of bits to be changed based on a difference between the first and second light emission rates. The at least one bit of changed subfield data may be a higher order bit.

### BRIEF DESCRIPTION OF THE DRAWINGS

The above and other features and advantages will become more apparent to those of ordinary skill in the art by describing exemplary embodiments with reference to the attached drawings, in which:

FIG. 1 illustrates a plasma display device according to an exemplary embodiment of the present invention;

FIG. 2 illustrates an arrangement of subfields according to an exemplary embodiment of the present invention;

FIG. 3 illustrates a schematic block diagram of a controller according to an exemplary embodiment of the present invention;

FIG. 4 illustrates a flow chart of an operation of the controller according to an exemplary embodiment of the present invention;

FIG. 5 illustrates subfield data generated from a subfield data generator in FIG. 3 according to an exemplary embodiment of the present invention;

FIGS. 6 and 7 illustrate changing of subfield data by a subfield data changing unit in FIG. 3 according to exemplary embodiments of the present invention; and

FIGS. 8A and 8B illustrate generation of image blur with and without changing subfield data in accordance with embodiments, respectively.

### DETAILED DESCRIPTION OF THE INVENTION

Korean Patent Application No. 10-2007-0111555, filed on Nov. 2, 2007, in the Korean Intellectual Property Office, and entitled: “Plasma Display Device and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Accordingly, the drawings and description are to be regarded as illustrative in nature and not restrictive. Like reference numerals designate like elements throughout.

A plasma display device and its driving method according to embodiments of the present invention will now be described in detail.

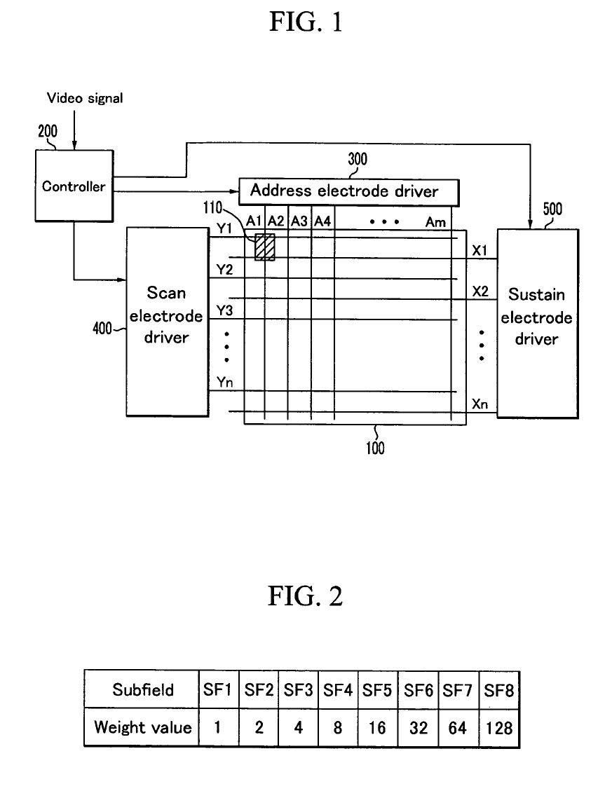

FIG. 1 illustrates a plasma display device according to an exemplary embodiment. FIG. 2 illustrates an arrangement of subfields according to an exemplary embodiment of the present invention.

As shown in FIG. 1, the plasma display device may include a plasma display panel (PDP) 100, a controller 200, an address electrode driver 300, a scan electrode driver 400, and a sustain electrode driver 500.

The PDP 100 may includes a plurality of address electrodes (referred to as ‘A electrodes’, hereinafter) A1˜Am extending in a column direction, and a plurality of sustain electrodes (referred to as ‘X electrodes’, hereinafter) X1˜Xn and a plurality of scan electrodes (referred to as ‘Y electrodes’, hereinafter) Y1˜Yn extending in a row direction as pairs. In general, the X electrodes X1˜Xn are formed to correspond to respective Y electrodes Y1˜Yn, and the X electrodes X1˜Xn and the Y electrodes Y1˜Yn perform a display operation to display an image during a sustain period. The Y electrodes Y1˜Yn and the X electrodes X1˜Xn are disposed to be perpendicular to the A electrodes A1˜Am. Discharge spaces existing at crossings of the A electrodes A1˜Am and the X and Y electrodes X1˜Xn and Y1˜Yn form discharge cells 110. Phosphor layers of red (R), green (G) and blue (B) may be alternately formed in a row direction at the A electrodes A1˜Am, so it is assumed that the discharge cells 110 of red, green and blue are alternately arranged in the row direction on the PDP 100. It is to be noted that the above construction of the PDP is only an example, and panels having different structures may employ driving waveforms to be described later according to embodiments.

The controller 200 may divide a single frame into a plurality of subfields each having a luminance weight value, each subfield including an address period and a sustain period.

The controller 200 may convert a plurality of video signals with respect to the plurality of discharge cells 110 into subfield data indicating whether or not light emission is performed in the plurality of subfields. For example, as shown in FIG. 2, there are eight subfields SF1˜SF8 having the weight values 1, 2, 4, 8, 16, 32, 64, and 128, respectively, representing gray scales of 0 to 255. The controller 200 may convert a video signal of 120 gray scales into subfield data of 00011110. Here, 00011110 sequentially correspond to the plurality of subfields SF1˜SF8, in which 1 indicates that a discharge cell emits light in the corresponding subfield, and 0 indicates that the discharge cell does not emit light during the corresponding subfield.

Also, the controller 200 may determine a point of time at which converted subfield data is output according to a light emission rate of the red, green and blue discharge cells 110. Namely, the controller 200 may measure a screen load ratio from a video signal input during the single period and determine a total number of sustain discharges allocated to the single frame. In this case, if the screen load ratio increases, the controller 200 may reduce the total number of sustain discharges to thus prevent an increase of power consumption. The controller 200 may allocate the number of sustain discharges allocated to the single frame to the plurality of subfields, respectively. The controller 200 may apply driving control signals to the address, scan, and sustain electrode drivers 300, 400, and 500 according to the changed subfield data and the number of allocated sustain discharges.

The address electrode driver 300 may apply a driving voltage to the plurality of A electrodes A1˜Am according to the driving control signal from the controller 200. The scan electrode driver 400 may apply a driving voltage to the plurality of Y electrodes Y1˜Yn according to the driving control signal from the controller 200. The sustain electrode driver 500 may apply a driving voltage to the plurality of X electrodes X1˜Xn according to the driving control signal from the controller 200.

Specifically, the address, scan, and sustain drivers 300, 400, and 500 may select light-emitting cells and non-light-emitting cells, among the plurality of discharge cells, during an address period of each sub-field. The sustain and/or scan drivers 400 and 500 may apply a predetermined number of sustain pulses allocated to the plurality of X electrodes X1˜Xn and/or the plurality of Y electrodes Y1˜Yn during the sustain period of each sub-field in order to repeatedly perform sustain discharges in the light-emitting cells.

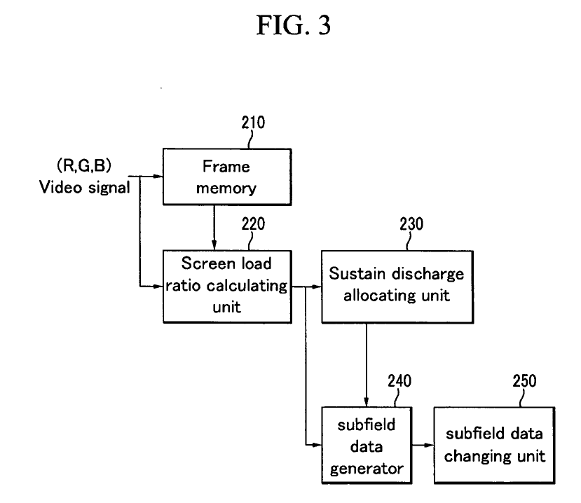

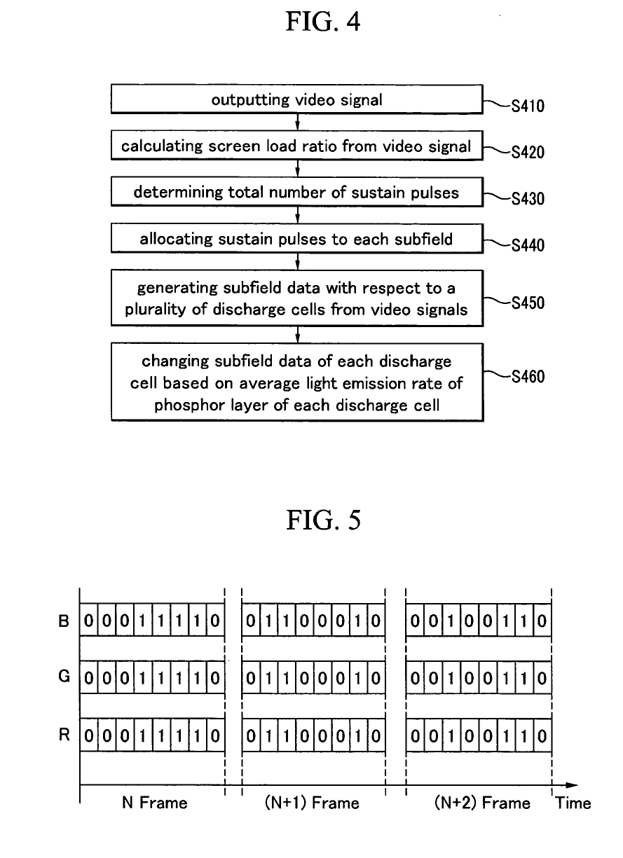

A method for reducing or removing image blurs generated due to an average light emission rate of phosphor will now be described in detail with reference to FIGS. 3 and 4. FIG. 3 illustrates a schematic block diagram of the controller 200 according to an exemplary embodiment of the present invention. FIG. 4 illustrates a flow chart of the operation of the controller 200 according to an exemplary embodiment of the present invention.

As shown in FIG. 3, the controller 200 may include a frame memory 210, a screen load ratio calculating unit 220, a sustain discharge allocating unit 230, a subfield data generator 240, and a subfield data changing unit 250.

The frame memory 210 may sequentially store video signals corresponding to a single frame and may sequentially output the stored video signals (S410). Thus, the controller 200 may simultaneously process a video signal of a current frame and that of a next frame through the frame memory 210.

The screen load ratio calculating unit 220 may calculate a screen load ratio based on a plurality of video signals input during a single frame (S420). For example, the screen load ratio calculating unit 220 may calculate a screen load ratio with an average signal level of image data of a single frame. Here, the plurality of video signals corresponds to the plurality of discharge cells 110 in FIG. 1, respectively.

The sustain discharge allocating unit 220 may determine a total number of sustain discharges allocated to a single frame according to the screen load ratio (S430), and may allocate the determined number of sustain discharges to the plurality of subfields in proportion to a luminance weight value of each subfield during the single frame (S440). In this case, the total number of sustain discharges according to the screen load ratio may be retrieved from a lookup table, or the total number of sustain discharges may be calculated by performing a logic operation on data corresponding to the screen load ratio. Namely, when the light-emitting cells increase, increasing the screen load ratio, the total number of sustain pulses may be reduced to prevent an increase in power consumption.

The subfield data generator 240 may determine whether or not the plurality of discharge cells are to emit light in each sub-field based on the plurality of video signals input during the single frame, and may generate subfield data according to whether or not the determined plurality of discharge cells emit light in each subfield (S450).

The subfield data changing unit 250 may change the subfield data of each discharge cell based on the average light emission rate of the phosphor layer of the plurality of discharge cells (S460), generate a driving control signal according to the changed subfield data, and apply the driving control signal to the address electrode driver 300.

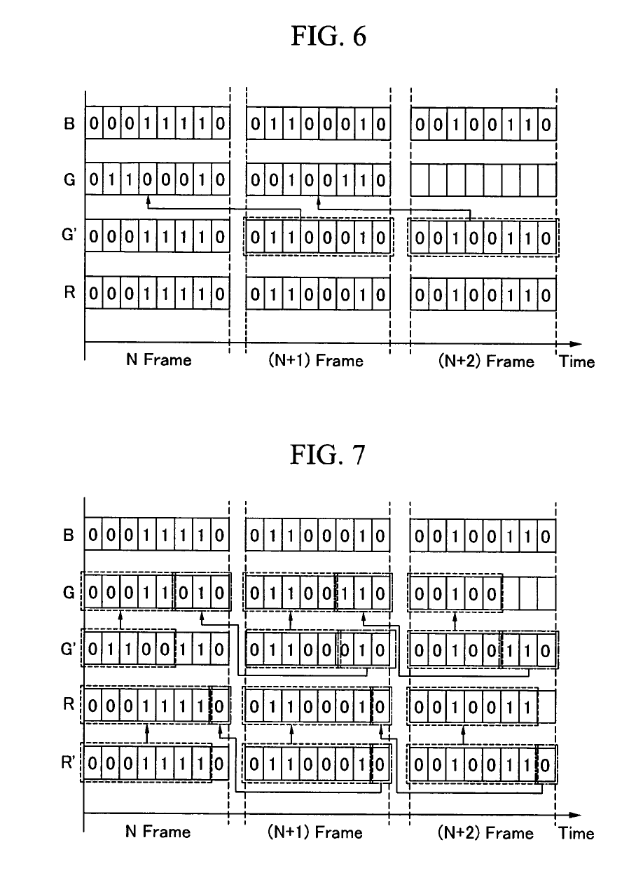

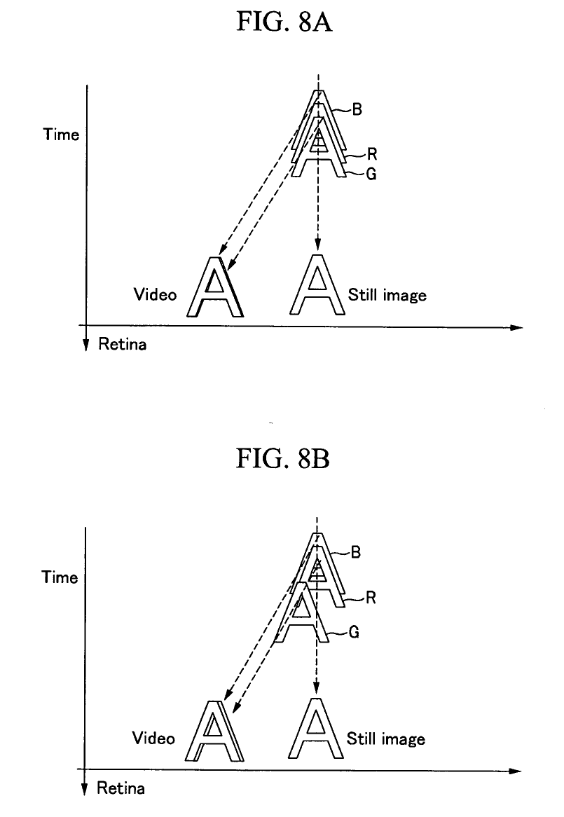

The method of changing the subfield data by the subfield data changing unit 350 will now be described with reference to FIGS. 5 to 8B. FIG. 5 illustrates the subfield data generated from the subfield data generator 240 in FIG. 3. FIGS. 6 and 7 illustrate changing of subfield data by the subfield data changing unit 250 in FIG. 3. FIG. 8A illustrates image blur generated when the subfield data is not changed in accordance with FIGS. 6 or 7. FIG. 8B illustrates an example that the image blur has been reduced or removed by changing the subfield data in accordance with an embodiment. In FIGS. 5 to 7, ‘R’, ‘G’, and ‘B’ indicate a single R, G, and B discharge cell, respectively.

First, the subfield data changing unit 250 may change subfield data of a discharge cell having a relatively slow average light emission rate among subfield data of the R, G, and B discharge cells generated by the subfield data generator 240. Then, the subfield data changing unit 250 may determine bits to be changed among higher-order bits of the subfield data having the relatively slow average light emission rate. The bits to be changed may be determined according to a difference of the average light emission rate based on a single discharge cell having the fastest average light emission rate.

For example, it is assumed that the subfield data of the R, G, and B discharge cells generated from the R, G, and B video signals input from N, (N+1), and (N+2) frames are 00011110, 01100010, and 00100110, respectively. Here, ‘N’ is a positive integer. In FIG. 5, it is assumed that the subfield data of the R, G, and B discharge cells are all the same in the N, (N+1), and (N+2) frames. In this case, when an average light emission rate of a phosphor layer of the G discharge cell is slower by one frame than that of phosphor layers of the R and B discharge cells, as shown in FIG. 6, the subfield data changing unit 250 may change the subfield data of the G discharge cell in the N frame to subfield data which has been converted from a video signal of the (N+1) frame (i.e., the following or subsequent frame). In addition, the subfield data changing unit 250 may change the subfield data of the G discharge cell in the (N+1) frame to subfield data which has been converted from a video signal of the (N+2) frame, the following one frame. In this case, the subfield data changing unit 250 does not change the subfield data of the R and B discharge cells having the relatively faster speed. G′ in FIG. 6 indicates subfield data of the G discharge cell shown in FIG. 5.

Unlike the case of FIG. 6, if the light emission rate of the phosphor is faster in the order of B, R, and G discharge cells, i.e., B is the fastest, and if the average light emission rate of the respective discharge cells is smaller than a one-frame difference, it is assumed that the average light emission rate of the G discharge cell is slower by three sub-fields than that of the B discharge cell and the average light emission rate of the R discharge cell is slower by one subfield than that of the B discharge cell, as shown in FIG. 7. The subfield data changing unit 250 does not change the subfield data of the B discharge cell having the fastest average light emission rate, but may change the subfield data of the G and R discharge cells having the relatively slow average light emission rates. In this case, as shown in FIG. 7, the subfield data changing unit 250 may change data of the higher-order 3 bits of the G discharge cell, which has an average light emission rate slower by the 3 subfields than that of the B discharge cell, corresponding to the difference (3 subfields) from the average light emission rate of the B discharge cell among the subfield data of the N frame, into data of the higher-order 3 bits of subfield data of the (N+1) frame. Likewise, the subfield data changing unit 250 may change data of the higher-order 1 bit among the subfield data of the R discharge cell, which has an average light emission rate slower by one subfield than that of the B discharge cell, to data of a higher-order 1 bit of the subfield data of the (N+1) frame.

More generally, when a first light emission rate of a first phosphor is faster than a second light emission rate of a second phosphor by j sub-fields, the subfield data changing unit 250 may change j-bits of subfield data of the second discharge cells in the N frame to corresponding j-bits of subfield data of the second discharge cells in the (N+1) frame. These j-bits may be the higher order bits. If the difference light emission rates is one-frame or more, the subfield data changing unit 250 may change all bits of subfield data of the second discharge cells in the N frame to all bits of subfield data of the second discharge cells in the (N+1) frame.

Thus, each point of time at which respective discharge cells emit light may be made to correspond, i.e., the respective discharge cells emit light at the same point of time, so the image blur phenomenon as shown in FIG. 8A generated in video by the average light emission rate of the phosphor may be reduced or prevented as shown in FIG. 8B. Although gray scales of the current frame may change because of the changed subfield data, the weight values of the subfields corresponding to the changed bits in each frame do not change, so the gray scale difference may not be noticed by a viewer.

As described above according to embodiments, image blur in a video image generated due to relative light emission rates of different phosphors may be reduced or eliminated.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display device having a plurality of discharge cells, the method comprising:
dividing a single frame into a plurality of subfield data each having a luminance weight value;
converting a plurality of video signals, each corresponding to the plurality of discharge cells, into a plurality of subfield data indicating whether or not light emission is performed in the plurality of subfields;
changing the converted subfield data based on light emission rates of the plurality of discharge cells; and
discharging the plurality of discharge cells with the changed subfield data.

2. The method as claimed in claim 1, wherein:
the plurality of discharge cells comprises a plurality of first discharge cells that emit light of a first color at a first light emission rate and a plurality of second discharge cells that emit light of a second color at a second light emission rate, and
changing the converted subfield data includes changing the converted subfield data for first discharge cells when the first light emission rate is slower than the second light emission rate and changing the converted subfield data for second discharge cells when the second light emission rate is slower than the first light emission rate.

3. The method as claimed in claim 2, wherein, when the second light emission rate is slower than the first light emission rate, changing the converted subfield data includes changing at least one bit of subfield data of the second discharge cells in an Nth frame to at least one bit of subfield data of the second discharge cells in a (N+1)th frame (where N is a positive integer).

4. The method as claimed in claim 3, further comprising determining a number of bits to be changed based on a difference between the first and second light emission rates.

5. The method as claimed in claim 3, wherein subfield data of the first discharge cells is not changed.

6. The method as claimed in claim 3, wherein, when the second light emission rate is slower than the first light emission rate by one frame or more, changing the converted subfield data includes changing all bits of subfield data of the second discharge cells in the N frame to all bits of subfield data of the second discharge cells in the (N+1) frame.

7. The method as claimed in claim 3, wherein, when the second light emission rate is slower than the first light emission rate by j sub-fields but less than one frame, changing the converted subfield data includes changing j-bits of subfield data of the second discharge cells in the Nth frame to corresponding j-bits of subfield data of the second discharge cells in the (N+1)th frame.

8. The method as claimed in claim 3, wherein the at least one bit of changed subfield data is a higher order bit.

9. The method as claimed in claim 1, further comprising:
calculating a screen load ratio from the plurality of video signals;
determining a total number of sustain pulses during the frame according to the screen load ratio; and
determining the number of sustain pulses allocated to each of the plurality of subfields based on the total number of sustain pulses.

10. A plasma display device, comprising:
a first discharge cell configured to emit light of a first color at a first light emission rate;
a second discharge cell configured to emit light of a second color at a second light emission rate;
a controller configured to divide a single frame into a plurality of subfields each having a weight value, convert video signals of the first and second discharge cells into first and second subfield data indicating whether or not light emission is performed in the plurality of subfields, and change one of the converted first and second subfield data based on a difference between first and second light emission rates; and
a driver configured to selectively make the first and second discharge cells emit light or not emit light according to the first and second subfield data.

11. The device as claimed in claim 10, wherein the controller comprises:
a subfield data generator configured to convert the video signals of the first and second discharge cells into the first and second subfield data, respectively; and
a subfield data changing unit configured to change subfield data of discharge cells among the first and second discharge cells having a lower light emission rate.

12. The device as claimed in claim 11, wherein, when the second light emission rate is slower than the first light emission rate, the subfield data changing unit is configured to change at least one bit of subfield data of the second discharge cells in an Nth frame to at least one bit of subfield data of the second discharge cells in a (N+1)th frame (where N is a positive integer).

13. The device as claimed in claim 12, wherein the subfield data changing unit is configured to determine a number of bits to be changed based on a difference between the first and second light emission rates.

14. The device as claimed in claim 12, wherein the subfield data changing unit is configured to maintain subfield data of the first discharge cells.

15. The device as claimed in claim 12, wherein, when the second light emission rate is slower than the first light emission rate by one frame or more, the subfield data changing unit is configured to change all bits of subfield data of the second discharge cells in the Nth frame to all bits of subfield data of the second discharge cells in the (N+1)th frame.

16. The device as claimed in claim 12, wherein, when the second light emission rate is slower than the first light emission rate by j sub-fields, the subfield data changing unit is configured to change j-bits of subfield data of the second discharge cells in the Nth frame to corresponding j-bits of subfield data of the second discharge cells in the (N+1)th frame.

17. The device as claimed in claim 12, wherein the at least one bit of changed subfield data of the second discharge cells is a higher order bit.

18. A method for driving a plasma display device having a plurality of discharge cells, the method comprising:
dividing a single frame into a plurality of subfield data;
converting video signals of first and second discharge cells input during an Nth frame into first and second subfield data (where N is a positive integer);
converting video signals of the first and second discharge cells input during a (N+1)th frame into third and fourth subfield data, respectively;
changing at least one bit of the second subfield data in the Nth frame into at least one bit of the fourth subfield data of the (N+1)th frame when a second light emission rate of the second discharge cell is slower than a first light emission rate of the first discharge cell; and
selectively making the first and second discharge cells emit light or not emit light based on the first subfield data and the changed second subfield data in the Nth frame.

19. The method as claimed in claim 18, further comprising determining a number of bits to be changed based on a difference between the first and second light emission rates.

20. The method as claimed in claim 18, wherein the at least one bit of changed subfield data is a higher order bit.
